(19) United States
(12) Patent Application Publication
(10) Pub. No.: US 2006/0179076 A1
(43) Pub. Date: Aug. 10, 2006

(54) Integration of a digital asset management system with a project management system

(76) Inventors: Jutta Weber, Mannheim (DE); Volker Faisst, Iiveshelm (DE)

Correspondence Address: KENYON & KENYON, 1500 K STREET N.W., WASHINGTON, DC, 20005, US

(21) Appl. No.: 11/261,782

(22) Filed: Oct. 31, 2005

Related U.S. Application Data
(60) Provisional application No. 60/650,966, filed on Feb. 9, 2005.

(51) Int. Cl. G06F 7/00

(52) U.S. Cl. 707/102

(57) ABSTRACT

The disclosure relates to an integrated system comprising a digital asset management system, a project management system, and an interface that permits the integration of the two systems. Data may be accessed or replicated between the two systems via the interface. Among operations facilitated by the integrated system is the accessing of digital assets of the digital asset management system by the project management system via the interface to serve as the basis for the production of a new digital asset or asset version.

This application claims the benefit under 35 USC 119(e) of U.S. provisional application 60/650,966, filed Feb. 9, 2005 and fully incorporated herein by reference.

### BACKGROUND OF THE INVENTION

A “digital asset” is a data object that carries marketable information content. Thus, the term covers various multimedia files, including image files, audio files (e.g., music), audio-video files and the like. The term also may cover text files or data files, such as product reports, analyses, recommendations, etc. Digital assets may be sold among various participants in a market. The assets typically are sold in contracts that limit ways in which a purchasing party may use the digital asset.

Digital asset management systems, as their name implies, are computer systems that permit asset owners to manage their assets. For example, a digital asset management system may permit consumer product manufacturers (who manufacture an array of products) to manage their retailers' or advertisers' use of product images throughout advertisements and other commercial notices regarding the products themselves.

In known digital asset management systems, consumers' user experiences in browsing through and retrieving digital assets may be awkward and non-intuitive. Therefore, there is a need in the art for a digital asset management system that is easy to use.

Project management software tools are also known. Such tools may be used to define phases and requirements of a project, for example. Traditionally, the project management tools support manufacture of physical goods such as consumer products, and thus are focused on raw materials, production processes, inventories of finished products, and the like.

The present inventors have recognized that the development of a digital asset or assets may be undertaken as a project, in a way that is analogous to the way physical goods are manufactured as projects. The present inventors have further had the novel realization that, given this analogy, there is a need to integrate project management concepts with a digital asset management system so that the advantages of both these disciplines can be mutually enhanced.

### BRIEF DESCRIPTION OF THE DRAWINGS

FIG. 1 shows an integrated system according to embodiments of the present invention, comprising a digital asset management system, a project management system, and an interface therebetween;

FIG. 2 shows a digital asset management system according to embodiments of the present invention;

FIG. 2A shows an example of structure of a digital asset according to embodiments of the present invention;

FIG. 3 shows a project management system according to embodiments of the present invention;

FIG. 3A shows a process description according to embodiments of the present invention;

FIGS. 4A, 4B and 4C show process and data flows according to embodiments of the present invention;

FIGS. 5-8 show examples of screen displays of the digital asset management system;

FIG. 9 illustrates a digital asset life cycle according to embodiments of the present invention; and

FIG. 10 shows a process flow according to embodiments of the present invention for integration of a digital asset with an Internet sales system.

### DETAILED DESCRIPTION

Embodiments of the present invention relate to methods and systems for integrating a digital asset management system with a project management system to address the above-described needs. Thus, embodiments of the present invention may comprise a digital asset management system, a project management system, and an interface that permits the integration of the two systems. Data may be accessed or replicated between the two systems via the interface.

The digital asset management system may comprise an efficient digital asset storage, search and retrieval capability, and a number of convenient user interface features. The project management system may enable the definition of a project whereby the production of a new digital asset or digital asset version may be carried out.

As described in more detail further on, operations made possible by integration of the digital asset management system with the project management system may include, for example, the accessing of digital assets of the digital asset management system by the project management system to serve as the basis for the production of a new digital asset or asset version. The digital asset management system may subsequently be used to control a post-production phase of a life cycle of the new digital asset or digital asset version by, for example, providing a search and download capability whereby the new digital asset or digital asset version is made available to consumers in the marketplace, and by setting conditions on use of the digital asset or digital asset version.

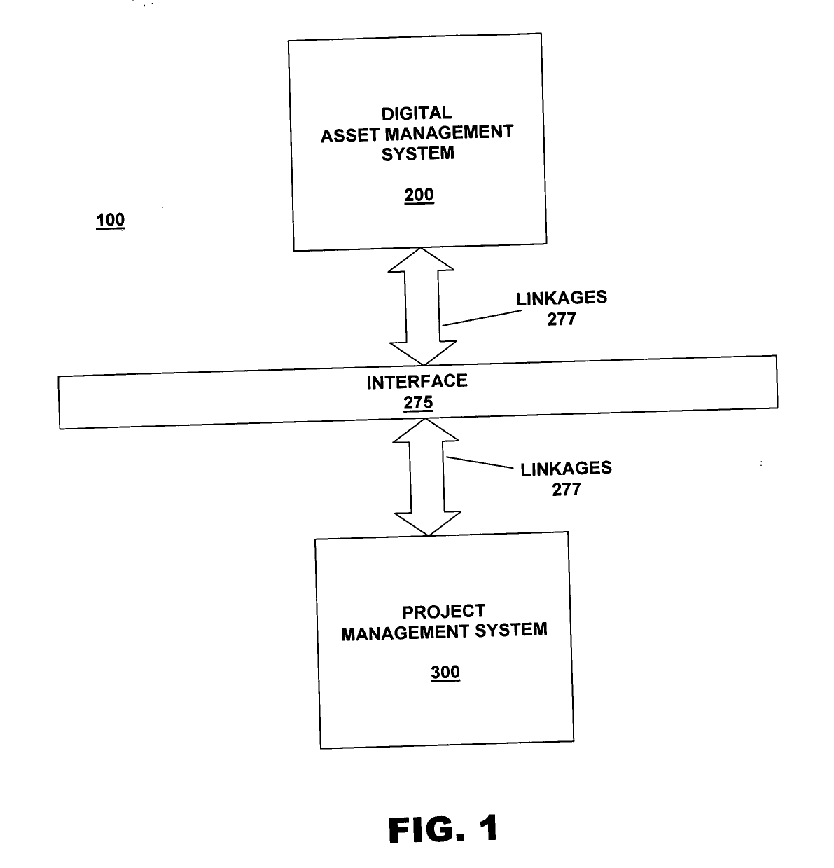

FIG. 1 illustrates an integrated system 100 according to embodiments of the present invention. In the integrated system 100, digital assets of a digital asset management system 200 according to embodiments of the present invention may be accessed by a project management system 300, and/or replicated between the digital asset management system 200 and the project management system 300, via an interface 275 and linkages 277.

Both the digital asset management system 200 and the project management system 300 may be network-based. Thus, the interface 275 may comprise the physical interconnections and media, such as routers, switches, cables, wireless transmission and reception equipment, and the like, for electronically propagating information in a network. The interface 275 may further include higher-level control logic and computers, such as connectivity protocols like TCP/IP and various client/server applications and their associated hardware platforms.

Each of the digital asset management system 200 and the project management system 300 may comprise a communications management application for managing communication via the interface 275. In embodiments, the communications management applications may comprise web services and/or process agents.

The digital asset management system 200 and the project management system 300 may include objects and use object-oriented methods. As is known, a software object may include data and an interface through which other objects can read, change or add to the data. Linkages may be formed between objects. Though it is typically transparent to the object-oriented programmer, in embodiments objects may be implemented at least in part as tables comprising a plurality of modifiable entries that collectively exhibit the behavior that characterizes an object and that can logically link objects.

Turning first to a more detailed description of the digital asset management component of the integrated system 100, the system 200 may provide for digital asset storage, search and retrieval, and a number of advantageous user-friendly features for ease of use. The system may access stored digital assets using a hierarchical classification system, providing for efficiency in search and retrieval. Conditions on the use of each digital asset may be included with each digital asset, providing needed controls.

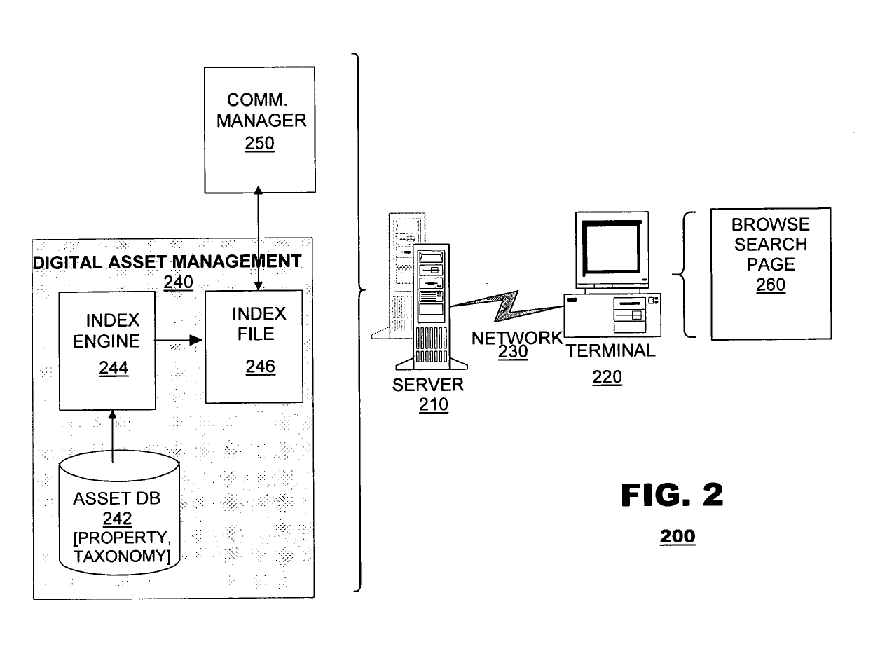

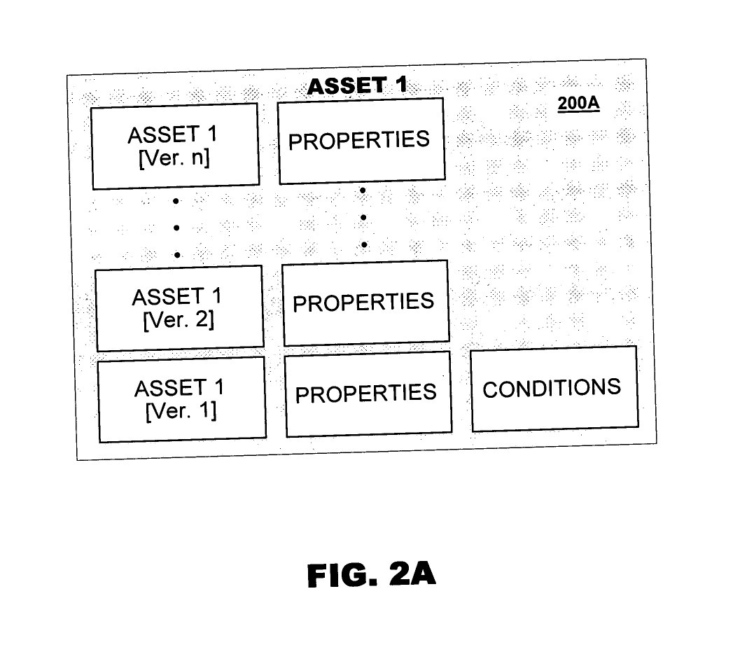

FIG. 2 illustrates a digital asset management system 200 according to embodiments of the invention. The system 200 may comprise a server 210 and a terminal 220, connectable to the server 210 by a communication network 230. The network may include or be part of, for example, the Internet or World Wide Web, but could also include or be part of any wide area network (WAN) or local area network (LAN). The server 210 may include a processor and a memory coupled to the processor. The server 210 may further include storage media storing computer-executable instructions to implement a digital asset management application 240 and a communication manager 250. The server 210 may execute the digital asset management application 240 and the communication manager 250.

The communication manager 250 may manage communication with the terminal 220. In particular, the communication manager may send web pages, such as a browse search page 260, interactively generated by the digital asset management application 240, via the network 230 to a client at the terminal 220. Further, the communication manager 250 may manage communication via the interface 275 (which may be implemented at least in part by the network 230) with the project management system 300.

The digital management application 240 may further comprise a database 242 storing digital assets. An index engine 244 of the digital asset management application 240 may access digital assets in the database 242 to form an index file 246. The index file 246 may be used, among other things, for responding to user requests by generating web pages for sending to the user. Specifically, the digital management application 240 may receive user requests entered by a user at a terminal 220, and execute the index engine 244 to access the asset database 242 to respond to the requests. The requests may be, in particular, search parameters entered in a browse session in order to locate a desired digital asset. Based on the search parameters entered, the user may be caused to navigate through a series of displays.

Tree structures associated with the digital assets may determine a navigation path through the displays. As is well known, a tree structure in software terms may define a hierarchy of nodes, including “root” or “parent” nodes and various levels of “child” nodes. In embodiments of the present invention, the tree structures or hierarchies may be used to implement a taxonomy or classification system under which assets are organized and classified based on their properties. The hierarchies may be built, for example, by a system administrator or other system operator who uses a GUI (graphical user interface) to define classes and related subclasses. A given asset, depending on its properties, could belong to more than one hierarchy.

FIG. 2A shows a data structure for a digital asset 200A according to embodiments of the invention. A digital asset 200A may include multiple parts. The parts may include files of all kinds. The files may include, for example, one or more media objects, such as a picture, movie, song, data or the like. The digital asset may contain multiple versions of the files, including a latest or active version, and all previous versions.

A digital asset and its versions may be viewed as a “logical information object” (LOIO) and “physical information objects” (PHIOs), respectively. A digital asset as a LOIO may be thought of as representing a general concept or category—say, “Advertisement for a diaper.” A succession of versions of the digital asset represent various actual realizations of a diaper advertisement, or PHIOs. It should be understood that, as used herein, “digital asset,” unless distinguished from a version, generally means a version of a digital asset, i.e., a PHIO.

The digital asset 200A may further include properties. The properties may be used to classify the digital asset. The properties may apply to specific versions and be different for different versions. For example, the properties may identify which of the versions of a digital asset is the active version. Properties may also apply to the digital asset 200A as a whole and not to a specific version.

As noted, the properties may identify which of possibly many versions is active (i.e., valid or currently in effect). Only one version can be active at a time. When a new version is added to the digital asset, it need not be identified as active. For example, it can be a work in progress not yet ready for release to other parties. When a new version is identified as active, however, a formerly active version will be designated not active. The digital asset management system may review these activeness designations within a properties field to determine which media object to release to external parties.

The digital asset 200A may further include conditions on its use. The conditions may be specified, for example, as a text field, to be reviewed manually by external parties to ensure compliance with the conditions. For example, the conditions may identify a date range for which the external party is entitled to use the digital asset. The conditions could also be in the form of separate documents or files, such as .pdf or .doc files. Conditions may be inherited—propagated among related digital assets. This ensures data integrity and ensures that valid conditions are assigned to all affected digital assets.

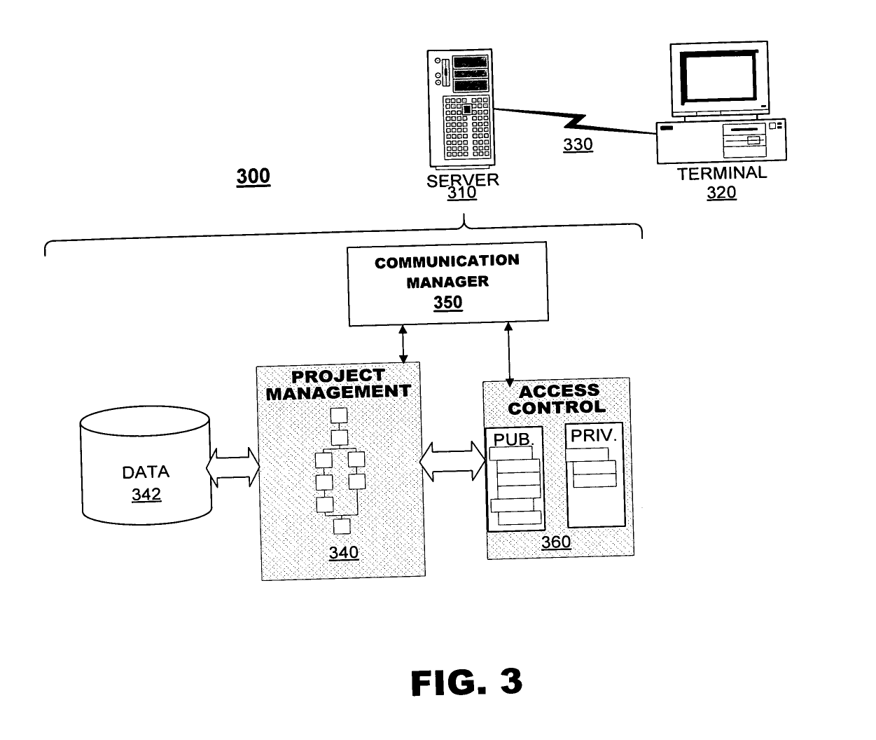

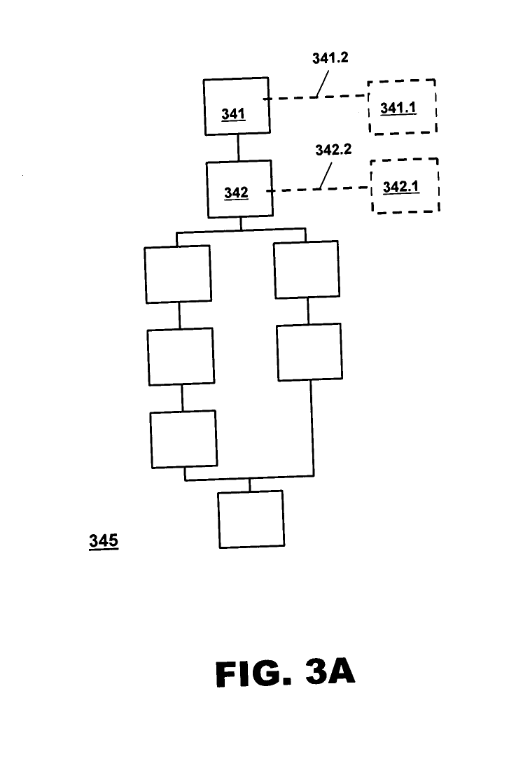

FIG. 3 shows a project management system 300 according to embodiments of the present invention. Like the digital asset management system, the project management system 300 may be network-based. For example, the project management system 300 may be deployed on one or more servers 310 and terminal(s) 320, connectable to the server 310 by a communication network 330. The network may include or be part of, for example, the Internet or World Wide Web, but could also include or be part of any wide area network (WAN) or local area network (LAN). The server 310 may include a processor and a memory coupled to the processor. The server 310 may further include storage media storing computer-executable instructions to implement a project management application 340, an access control application 360, and a communication manager 350. The server 310 may execute the project management application 340, access control application 360, and communications manager 350.

The communication manager 350 may manage communication with the terminal 320. In particular, the communication manager 350 may interact with a client at the terminal 320 by exchange of web pages via the network 330. The web pages may be generated by the project management application 340 and the access control application 360. Further, the communication manager 250 may manage communication via the interface 275 (which may be implemented at least in part by the network 330) with the digital asset management system 200.

It is noted that the digital asset management application 240, the project management application 340, the access control application 360 and the communication managers 250 and 350 need not execute on physically distinct hardware platforms. For example, server 210 and server 310 could be the same server which may act as a “portal” to all of the applications.

Operations enabled by the project management application 340 may include defining and monitoring various aspects of a project's structure, such as its phases, tasks, checklists, timetables and personnel. The checklists may be used, for example, to ensure a controlled transition between phases of a project (e.g., some minimal set of criteria must be met or “checked off” before proceeding to a next phase). Data 342 relating to a project may be stored on a machine-readable medium such as disk.

FIG. 3A shows a more detailed view of one possible output of a project management application 340 according to embodiments of the present invention. As noted earlier, conventional project management tools support manufacture of physical goods. By contrast, though also suitable for traditional applications, the project management application 340 according to embodiments of the present invention further supports the production of digital assets. More specifically, the project management application 340 may support the definition of a workflow or process description 345 comprising a plurality of workflow stages (e.g., stages 341 and 342). The definition of a workflow may begin with a general template that could be adapted to a particular project depending on the application. Workflows typically identify a plurality of steps to be performed during creation of a particular object; they may identify a sequence of the steps and persons that are to perform the steps. According to an embodiment of the present invention, when using a workflow object to manage creation of a digital asset, the workflow object may include storage for components of the digital asset itself or links to the digital asset components on a network storage space.

An example of a project that generates digital assets is the production of a video with a musical score. A workflow for the production of the video could comprise, for example, tasks such as the booking of a studio, the hiring of musicians and other performers, the hiring of a director and camera crew, and so on. Other stages could include capturing various performances on recording media. For example, multiple takes of a performance could be captured on videotape or audiotape. Takes might be performed individually. For example, a drummer might perform several rhythm tracks separately from other musicians and then the best track might be selected and combined with a vocalist's and guitarist's separate performance. The workflow may specify steps for capturing each of these performances, for editing the performances into a composite musical score and then synchronizing the musical score with the video. Similarly, there may be steps defined for capturing and editing video performances prior to synchronizing the video performance with the musical score.

Each of these captured performances represents a digital asset component (assuming a subsequent translation of a performance into a digitized form that can be stored on a machine-readable medium, uploaded and downloaded and so on). During creation of the digital asset, as operator(s) progress through the workflow to create the asset, the digital asset components may then be linked with the workflow stage that generated it. For example, as shown in FIG. 3A, workflow stage 341 generates digital asset 341.1, which is linked by linkage 341.2 to workflow stage 341. Similarly, workflow stage 342 generates digital asset 342.1, which is linked by linkage 342.2 to workflow stage 342. Again, the workflow stages and digital assets may be at least partly implemented as objects and the linkages as entries in tables or the like that logically connect the objects. Advantages of the workflow with its linked digital assets include the efficient organization of projects, which may be quite complex, and fast and easy adaptation of projects to changing needs. This is because a workflow object is directly linked to its product in a computer, in contrast to conventional workflows which model performance of processes upon physical products.

Collaboration on a project by external entities may be possible via the access control application 360. The access control application 360 may control access to project data to keep some data private to a network while permitting distribution of other data, e.g., to outside business partners, as needed. Access may be based on an authorization scheme, wherein outside entities are assigned different levels of authorization that enable corresponding different levels of access. The access control application 360 and the projection management application 340 may communicate via linkages.

An example of a known project management application is SAP® AG's cprojects. An example of a known access control application is SAP® AG's cFolders.

A description of several possible processes that may be performed on the integrated system 100 now follows. In a first process, Process 1, digital assets stored in the digital asset management system 200 are directly accessed from the project management application 340. In a second process, Process 2, digital assets are transferred (e.g., replicated) between the digital asset management application system 200 and the access control application 360. A linkage to the project management application 340 may enable management of project tasks. In a third process, Process 3, digital assets are transferred between the access control application 360 and the digital asset management system 200.

To perform the above-noted actions, the digital asset management system 200 may include user interface functionality to perform operations with respect to the access control application 360. Similarly, the access control application 360 may include user interface functionality to perform operations with respect to the digital asset management system 200. The project management application 340 may include user interface functionality to directly access the access control application 360 (for managing the collaboration with external partners) and the digital asset management system 200 (for utilizing digital asset management system capabilities during the management of a digital asset production project). Using these functionalities, a user may select, designate or otherwise perform one or more operations which cause the digital assets to be transferred to or accessed by an application.

Process 1. Accessing Digital Assets of the Digital Asset Management System from the Project Management Application

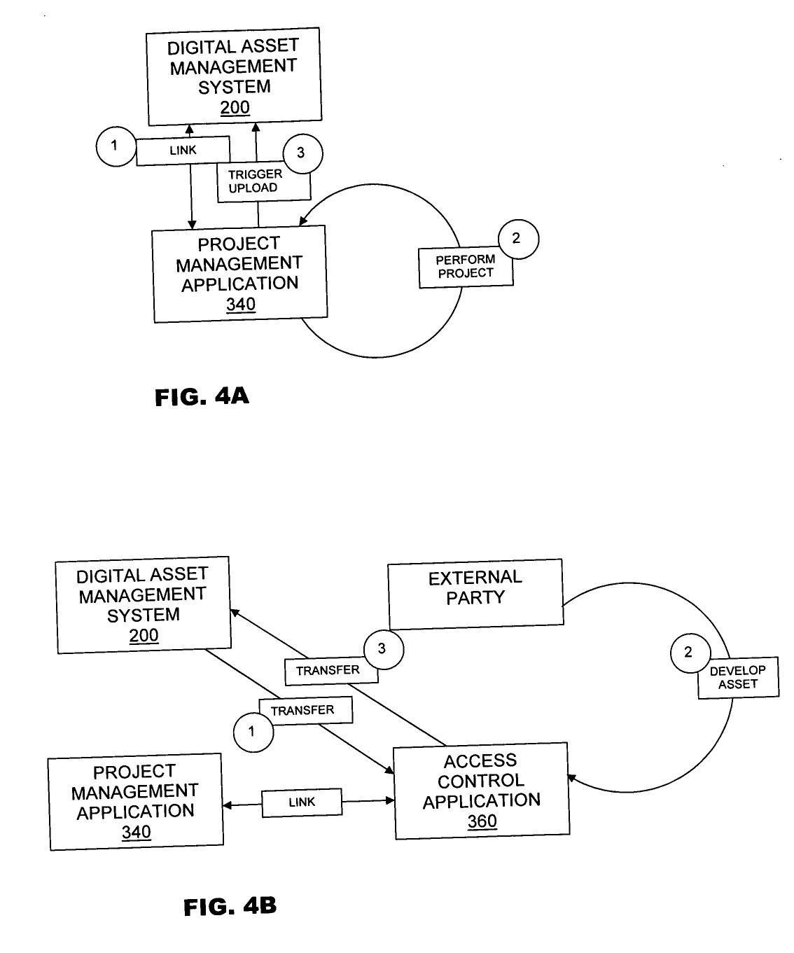

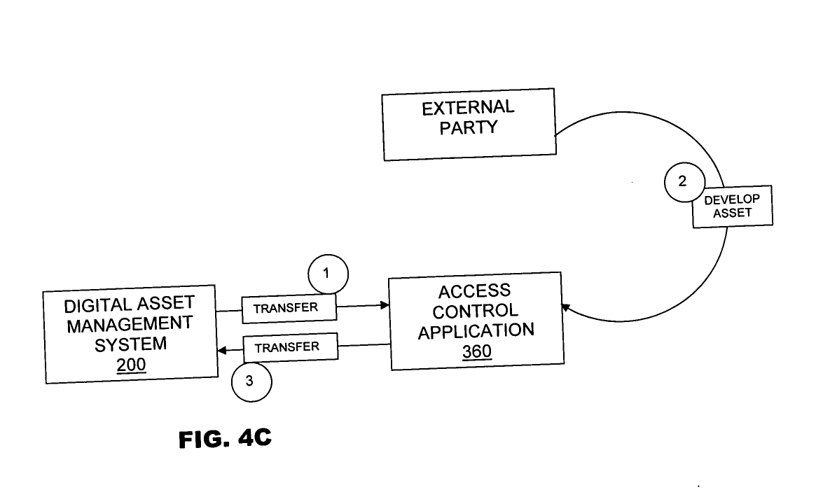

Referring to FIG. 4A, in Process 1, one or more existing digital assets or digital asset versions on the digital asset management system 200 are (1) accessed by project management application 340 via a link to serve as a basis (i.e., starter material or prototype) for producing a new digital asset or digital asset version. The linkage, more specifically, may be between an existing digital asset or digital asset version and a corresponding project that is created on the project management application 340. The project may be implemented at least in part as a software object.

A different order of events is possible. For example, a new project may first be created, before a corresponding digital asset(s)/version(s) on the digital asset management system is linked to the project.

In any event, a project manager may then proceed to define project tasks, timeliness personnel and the like using functionality of the project management application, to develop the new digital asset or digital asset version from the existing digital asset(s) or digital asset version(s). The project may (2) be performed. In due course, the new digital asset or digital asset version created in the project management application 340 may be created in the digital asset management system 200, e.g. by (3) triggering an upload (provided through direct access to the digital asset management system and its capabilities) of the new digital asset or digital asset version from the project management application 340 to the digital asset management system 200. If the uploaded digital asset is a new digital asset version, it may be stored with previous versions in the corresponding digital asset (see FIG. 2A) and have its status set to “active.” If the uploaded digital asset is a new digital asset (i.e., it is as yet the sole version) its status may also be set to “active.”

Of course, it should be understood that Process 1 need not necessarily begin with a link to an existing digital asset or digital asset version in the digital asset management system 200 to a project in the project management application 340. Instead, a new digital asset or digital asset version could be developed on the project management system 300 independently of any pre-existing digital asset or digital asset version on the digital asset management system 200, and then uploaded to the digital asset management system 200.

Process 2. Digital Assets Between Digital Asset Management System and Access Control Application, with Linkage to Project Management Application

Referring to FIG. 4B, in Process 2, existing digital assets or digital asset versions are (1) transferred from the digital asset management system 200 to the access control application 360 so that external parties can collaborate in a project to create a new digital asset or digital asset version. The digital assets or digital asset versions may, for example, be transferred to a data storage area accessible via a network to a business partner having a given authorization level. In addition, the digital assets or digital asset versions in the access control application 360 may be linked to a project in the project management application 340, where all internal project tasks are managed.

The business partner may work on the digital assets to (2) develop a new digital asset or digital asset version. This new digital asset or digital asset version may then be (3) transferred back to the digital asset management system 200. If the digital asset is a new digital asset version, it may be stored with previous versions in the corresponding digital asset and have its status set to “active.” If the digital asset is a new digital asset (i.e. no earlier versions) its status may also be set to “active.”

Process 3. Digital Assets Between Digital Asset Management System and Access Control Application

Referring to FIG. 4C, in Process 3, existing digital assets or digital asset versions are (1) transferred from the digital asset management system 200 to the access control application 360 so that external parties can collaborate in a project to create a new digital asset or digital asset version. The digital assets or digital asset versions may be transferred to a data storage area accessible via a network to a business partner having a given authorization level.

A corresponding access control object (e.g. a “collaboration folder”) may be created on the access control application 360. User interface functionality, for example, may be provided for this purpose. The business partner may work on the digital assets or digital asset versions to (2) develop a new digital asset or digital asset version. This new digital asset or digital asset version may then be (3) transferred back to the digital asset management system 200. The new digital asset or digital asset version and a corresponding access control object may be automatically linked as related objects. If the new digital asset is a new digital asset version, it may be stored with previous versions in the corresponding digital asset and have its status set to “active.” If the digital asset is a new digital asset (no previous versions) its status may also be set to “active.”

Along lines discussed earlier, a new digital asset or digital asset version could be developed by an external party using the access control application 360 independently of any pre-existing digital asset or digital asset version on the digital asset management system 200, and then transferred to the digital asset management system 200.

In a variation of Process 3, separate access control objects may be created for each of a number of external competitors in a collaborative project. Digital assets may be linked with respective ones of the separate access control objects and each of the external competitors may work on the digital assets to produce a new digital asset or digital asset version. These various new digital assets or digital asset versions may then be judged, for example, and a winning digital asset or digital asset version selected for transfer to the digital asset management system 200.

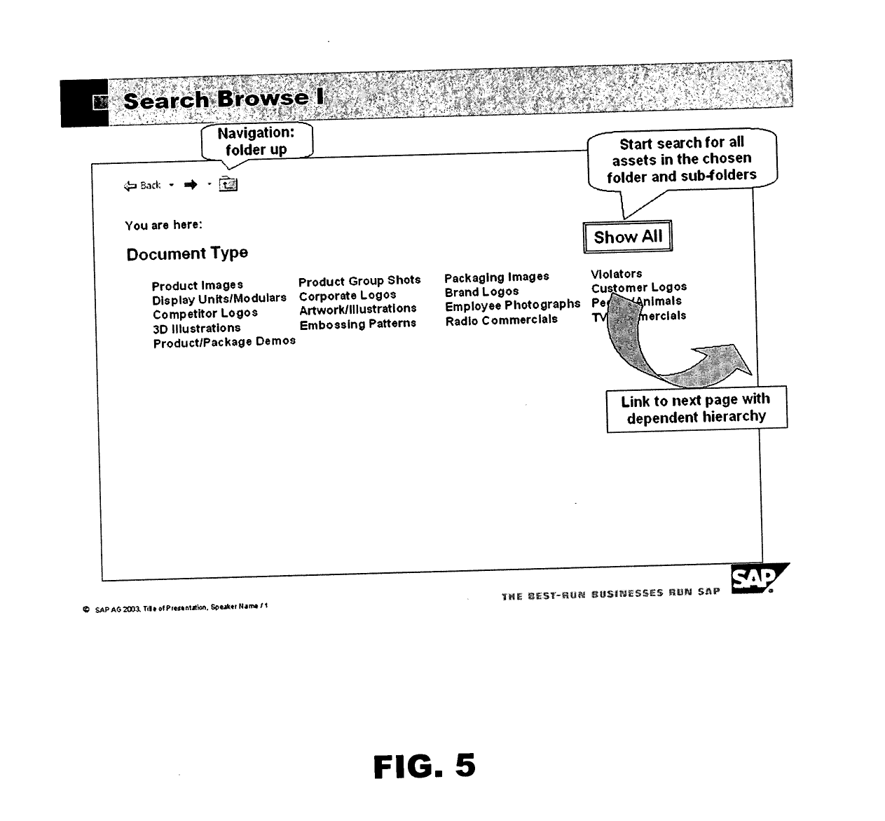

Components of the digital asset management system 200 have been described above. The components provide a number of convenient user features. Among these is a browse search capability. Browse search functionality according to embodiments of the present invention may use the hierarchical tree structures and their classifications to efficiently perform a search and present its results. FIG. 5 shows an example of a screen display that could be presented to a user, based on search parameters entered by the user. For example, a user might indicate that he wants to search for a digital asset. Possibly after one or more preceding displays (such as a log-on screen), the display of FIG. 5 may be presented to the user. The display shows a list of asset (document) types. Each list item (e.g., “Product Images” or “Customer logos”) represents a root node in a hierarchical tree structure.

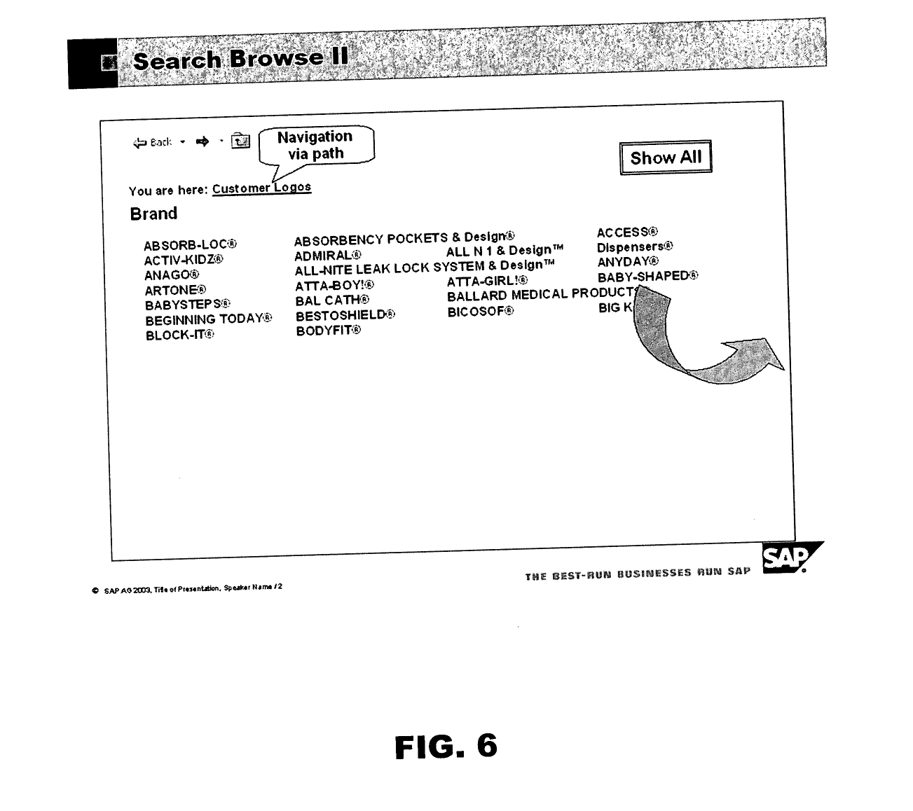

Each root node in the hierarchy may have child nodes representing a further refinement of the classification assigned to the root node. By selecting a node (e.g. by “clicking” on the corresponding field or otherwise querying or activating a node), a user may see a display of the next-lower level in the hierarchy. FIG. 6, for example, shows a display that a user might see by selecting the “Customer Logos” field and clicking on “Show All”. A list of specific customer logos is presented. Again, each specific customer logo may represent a node, classified according to a taxonomy, in a hierarchy. A user may be able to navigate upward or downward (or, backward or forward from another perspective) in the hierarchy. Moreover, a display could show more than one level of a hierarchy. For example, a display could show both child nodes and grandchild nodes of a higher-level node.

In an advantageous feature according to embodiments of the invention, a search or navigation path report 601, which indicates the path taken through a given hierarchy up to the current screen display, may be provided. The example of FIG. 6 is rather simple but it is illustrative. In actual practice navigation paths could be considerably more complex. This feature provides for a more convenient user experience because it can help the user recall how to reach a desired asset in the future, or assist the user in searching for similar assets.

When the browser is invoked, the digital asset management application 240 may determine which nodes of the hierarchy point to stored assets. “Empty” nodes, i.e., nodes to which some classification is assigned but which do not currently point to actual stored assets are not displayed. Also, nodes which contain only assets the user is not authorized to see are not displayed.

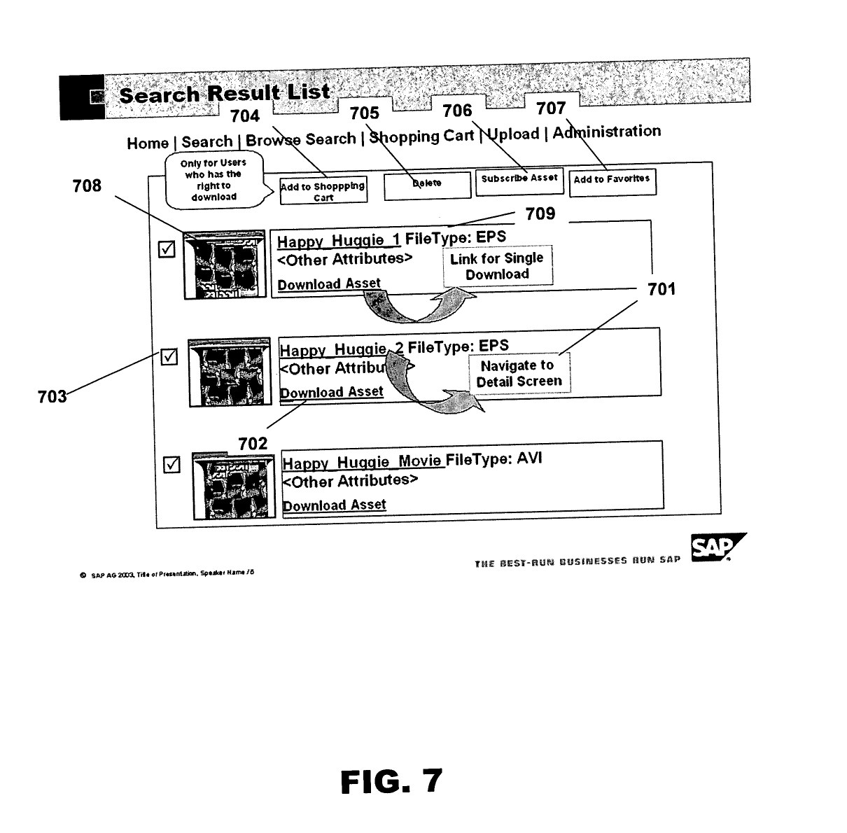

By selecting an item, say, “BABY-SHAPED®”, in the list of customer logos, a user may see the next-lower level in the hierarchy, as shown in FIG. 7. In this example, FIG. 7 represents a “results list” where nodes in the hierarchy correspond directly to stored digital assets.

As noted earlier, the same digital asset may belong to multiple different hierarchies, depending upon whether its properties fit to a given set of classifications of a hierarchy. However, the path to the digital asset may be different for each hierarchy. For example, one or more of the digital assets shown in FIG. 7 might have also been reached if the user had selected “Product Images” instead of “Customer Logos” as the root node. However, the path may have included a different series of nodes and corresponding displays, because of the way the nodes of the “Product Images” hierarchy were classified when this hierarchy was built. Thus, according to embodiments of the present invention, among other properties of a digital asset there may be a plurality of “path” properties. Each path property may identify all the levels of a given hierarchy that must be navigated in order to reach a results list.

Returning now to FIG. 7, a number of operations may be possible with a results list. For example, a user may be able to navigate to a detail view of a listed asset by clicking on a field such as box 701, download an asset on the list by clicking a field such as box 702, mark assets via a checkbox 703, add an asset or assets to a “shopping cart” (box 704), delete an asset (box 705), subscribe to an asset (box 706) (a subscriber may receive notification, via email e.g., when an asset changes) or add an asset to a “favorites” list (box 707). An asset may include a thumbnail picture 508 and a property, such as a file type 709.

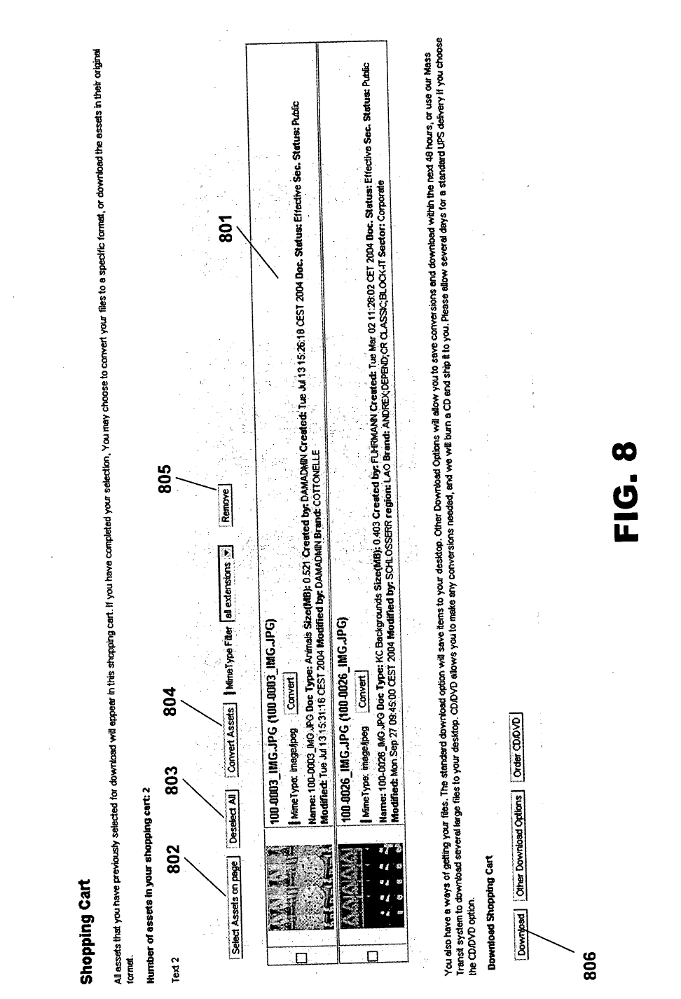

FIG. 8 shows an example of a shopping cart. A shopping cart in this context is a data container for selected assets. Shopping cart entries may include an asset report 801 that comprises such information about an asset as a file name and type, a creator of the asset and a create time, a version status (e.g. latest or active), a security status (e.g., access to the asset is public), a last-modified time, an identifier of the modifier, and the like.

Options further provided from the shopping cart may include selecting or de-selecting assets (boxes 802 and 803), converting an asset to a different file type (box 804), removing an asset from the shopping cart (box 805), and downloading selected assets (box 806). When an asset is downloaded, the asset report 801 may be downloaded along with the asset. The asset report 801 may further include hyperlinks (not shown) to downloaded assets. Additionally, the asset report is fully customizable via XSLT Style Sheets.

The above-described system may provide for mass upload/download of assets, or for upload/download of a single asset.

In another feature, a user can opt to assign a new filename to an exported asset. In typical scenarios, the user would select a product name or a document type as the new filename.

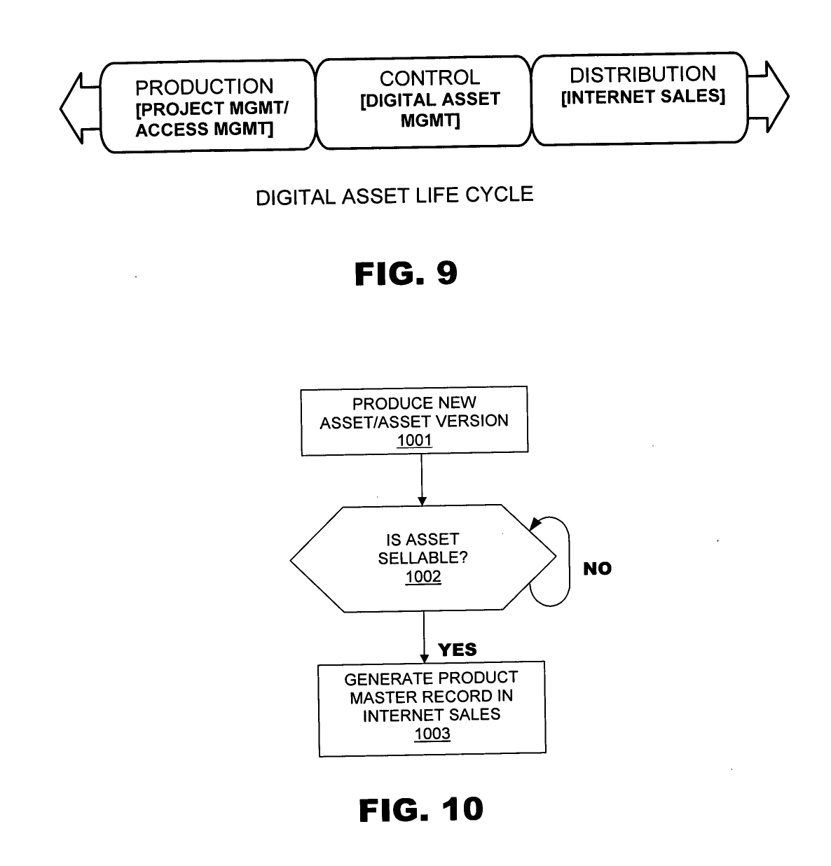

It may be appreciated in view of the foregoing that the project management system 300 and the digital asset management system 200 together can efficiently manage, respectively, a production phase and a post-production phase of a life cycle of a digital asset or asset version. A further phase of the life cycle may include a distribution phase, for example through Internet sales. The life cycle including the distribution phase is illustrated in FIG. 9.

Internet sales systems are known. They typically involve sales of physical goods. In some systems, each good is represented by a “product master” data object, which can identify, for example, product codes, product specifications, pricing, and so on.

According to embodiments of the present invention, Internet sales can be leveraged to support sales of digital assets. More specifically, after an asset is newly produced, it may be determined whether to extend the asset's life cycle into a distribution phase by integrating the asset into an Internet sales system. To this end, the digital asset management system 200 may include a profile that identifies digital assets as sellable or not sellable, for example based on asset type. The asset's type may be one of its properties.

FIG. 10 shows a process according to embodiments of the present invention for carrying out the above-described integration. As shown in block 1001, a new digital asset or asset version may be produced, for example by one of Processes 1, 2 or 3 described above. The production may include the assigning of an asset type as one of the asset's properties.

As shown in block 1002, it may be determined whether the new asset/asset version is sellable. The determination may be based on asset type. If it is determined that the asset is sellable, a product master for the new digital asset/asset version may be created and exported to an Internet sales system (block 1003).

The sellable/non-sellable decision could be overridden manually. Further, the Internet sales system could include functionality whereby the product master could be modified to change, for example, pricing, product specification or other sale information.

As noted earlier, embodiments of the present invention may comprise computer-executable instructions. The computer-executable instructions may be stored and transported on machine-readable media such as magnetic tape, floppy disk OR CD-ROM. The computer instructions may be retrieved from the machine-readable media using a suitable reading device into a memory and executed by a processor. The computer-executable instructions may be distributed across a plurality of media, such as on physically separate storage devices respectively associated with physically separate computer systems that may communicate via a network. The functionality disclosed hereinabove for performing the embodiments may find specific implementations in a variety of forms, which are considered to be within the abilities of a programmer of ordinary skill in the art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. An integrated system comprising:
a digital asset management system;
a project management system; and
an interface for the exchange of data between the systems, the interface including media for the propagation of electronic information;
the digital asset management system to at least store and retrieve a digital asset or digital asset version; and
the project management system to at least produce a new digital asset or digital asset version based on an existing digital asset or digital asset version of the digital asset management system.

2. The integrated system of claim 1, wherein the project management system comprises a project management application to define a project for the production of a new digital asset or digital asset version.

3. The integrated system of claim 1, wherein the project management system comprises an access management application to control access to a digital asset or digital asset version by an external party.

4. An automated method comprising:
linking an existing digital asset or digital asset version of a digital asset management system to a project of a project management application via an interface;
performing the project to produce a new digital asset or digital asset version based on the existing digital asset or digital asset version; and
uploading the new digital asset or digital asset version to the digital asset management system.

5. The method of claim 4, wherein the new digital asset version is stored with at least one previous version.

6. The method of claim 5, wherein the new digital asset version becomes an active version.

7. The method of claim 4, wherein the interface includes at least part of a network.

8. A machine-readable medium to store computer-executable instructions to perform a method according to claim 4.

9. An automated method comprising;
transferring, from a digital asset management system, an existing digital asset or digital asset version via an interface to an access control application;
receiving at the digital asset management system, from the access control application, a new digital asset or digital asset version based on the existing digital asset or digital asset version and produced by an external party provided access to the existing digital asset or digital asset version through the access control application; and
storing the new digital asset or digital asset version in the digital asset system.

10. The method of claim 9, wherein the access control system maintains private data and data for external distribution.

11. An automated method comprising:
receiving, at a digital asset management system, via an interface with an access control application, a new digital asset or digital asset version produced by an external party; and
storing the new digital asset or digital asset version in the digital asset system.

12. A machine-readable medium to store computer-executable instructions to perform a method according to claim 11.

13. An automated method comprising:
producing a new digital asset or digital asset version;
determining whether the asset is sellable;
if so, exporting the asset to an Internet sales system.

14. The method of claim 13, wherein the determining is based on a type of the asset.

15. A machine-readable medium storing computer-executable instructions to implement a project management application, the process management application to:
define a workflow comprising a plurality of stages; and
form a linkage between a workflow stage and a digital asset produced by the stage.
